(19) United States
(12) Patent Application Publication
(10) Pub. No.: US 2025/0305840 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Hironori Hirata, Tokyo (JP); Shun Iwasaki, Tokyo (JP); Yoshihiro Katsuyama, Tokyo (JP)

(73) Assignee: HONDA MOTOR CO., LTD., Tokyo (JP)

(21) Appl. No.: 19/064,740

(22) Filed: Feb. 27, 2025

(30) Foreign Application Priority Data
Mar. 27, 2024 (JP) 2024-050839

(51) Int. Cl. G01C 21/34; B60W 50/14; G01C 21/36

(52) U.S. Cl. CPC G01C 21/3446; B60W 50/14; G01C 21/3438; G01C 21/3685

(57) ABSTRACT

A control device for a moving object includes: an external environment recognition unit; a storage unit configured to store route information; and a movement control unit configured to perform movement control for moving the moving object. The route information includes route data indicating a movement route, stop position data indicating a stop position, and peripheral environment data indicating a feature of a peripheral environment and the stop position. When stop of the moving object at a first stop position identical to the stop position is detected, the movement control unit performs first generation of an exit route based on the route data and the stop position data. When stop of the moving object at a second stop position different from the stop position is detected, the movement control unit performs second generation of an exit route based on the route data and the peripheral environment data.

This application is based upon and claims the benefit of priority from prior Japanese patent application No. 2024-50839, filed on Mar. 27, 2024, the entire contents of which are incorporated herein by reference.

### TECHNICAL FIELD

The present disclosure relates to a control device, a control method, and a storage medium storing a control program.

### BACKGROUND ART

In recent years, efforts have been made to provide access to a sustainable transportation system in consideration of people vulnerable among traffic participants. In order to implement the above, focus has been placed on research and development on further improving safety and convenience of traffic by research and development related to self-driving techniques.

In the related art, there is known a remote parking system that remotely operates a vehicle using a smartphone to park the vehicle in a designated predetermined parking space or to cause the vehicle to exit from a parking space.

For example, JP2022-184506A describes a parking assistance device that recognizes landmark information indicating a feature of an area where the vehicle is to be parked based on sensing information from surrounding monitoring sensors, and stores route information in a form of a surrounding map such as a home map including not only a parking route of automatic parking but also the landmark information during the automatic parking, and uses the route information including the landmarks when estimating a host vehicle position.

### SUMMARY OF INVENTION

According to remote parking in the related art, since only movement route information and peripheral environment information during parking in a parking position where a vehicle used to be parked are stored, for example, if the vehicle is to be parked at a position other than the stored parking position, the vehicle cannot be caused to exit or called from the different parking position. JP2022-184506A describes storing route information including landmark information as described above, but does not describe causing a vehicle to exit or be called from a parking position other than the stored parking position.

Aspects of the present disclosure relate to providing a control device, a control method, and a storage medium storing a control program that are capable of flexibly performing movement control for moving a moving object to an exit position, thereby contributing to development of a sustainable transportation system.

According to an aspect of the present disclosure, there is provided a control device for a moving object, the control device including:
an external environment recognition unit configured to acquire external environment recognition data of the moving object;
a storage unit configured to store route information related to a movement route when the moving object moves from an entry start position to a stop position; and
a movement control unit configured to perform movement control for moving the moving object to an exit position based on the external environment recognition data and the route information, in which
the route information includes route data indicating the movement route, stop position data indicating the stop position, and peripheral environment data indicating a feature of a peripheral environment of the movement route and the stop position based on the external environment recognition data,
when stop of the moving object at a first stop position identical to the stop position indicated by the stop position data is detected, the movement control unit performs first generation of an exit route from the first stop position to the exit position based on the route data and the stop position data, and
when stop of the moving object at a second stop position different from the stop position indicated by the stop position data is detected, the movement control unit performs second generation of an exit route from the second stop position to the exit position based on the route data and the peripheral environment data.

According to another aspect of the present disclosure, there is provided a control method using a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data, the control method including:
when stop of the moving object at a first stop position identical to the stop position indicated by the stop position data is detected, performing, by the movement control unit, first generation of an exit route from the first stop position to the exit position based on the route data and the stop position data, and
when stop of the moving object at a second stop position different from the stop position indicated by the stop position data is detected, performing, by the movement control unit, second generation of an exit route from the second stop position to the exit position based on the route data and the peripheral environment data.

According to another aspect of the present disclosure, there is provided a non-transitory computer-readable storage medium storing a control program for a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data,
the control program causing the movement control unit of the control device to execute a process including:
   when stop of the moving object at a first stop position identical to the stop position indicated by the stop position data is detected, performing first generation of an exit route from the first stop position to the exit position based on the route data and the stop position data, and,
   when stop of the moving object at a second stop position different from the stop position indicated by the stop position data is detected, performing second generation of an exit route from the second stop position to the exit position based on the route data and the peripheral environment data.

According to aspects of the present disclosure, a control device, a control method, and a storage medium storing a control program that are capable of flexibly performing movement control for moving a moving object to an exit position may be provided.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device according to the present disclosure;

FIG. 2 is a top view of the vehicle 10 shown in FIG. 1;

FIG. 3 is a block diagram showing an example of an internal configuration of the vehicle 10 shown in FIG. 1;

FIG. 4 is a diagram showing an example of a hardware configuration of an information terminal 60 owned by a user of the vehicle 10;

FIG. 5 is a flowchart (part 1) showing movement control of a control ECU 20 when the vehicle 10 enters a garage;

FIG. 6 is a flowchart (part 2) showing the movement control of the control ECU 20 when the vehicle 10 enters a garage;

FIG. 7 is a flowchart showing movement control of the control ECU 20 when the vehicle 10 exits a garage;

FIG. 8 is a diagram showing an example of a notification that calling is possible;

FIG. 9 is a diagram showing an example of a notification that calling is impossible;

FIG. 10 is a diagram showing an example of a remote exiting screen displayed on an information terminal 60;

FIG. 11 is a diagram showing an example of a parking lot where the user causes the vehicle to enter and exit;

FIG. 12 is a diagram showing an example of the user driving a host vehicle V1 to park the host vehicle V1 in a parking space in a parking lot 70;

FIG. 13 is a diagram showing an example in which the user calls the host vehicle V1 parked in the parking lot 70;

FIG. 14 is a diagram showing an example of update of an exit route of the host vehicle V1;

FIG. 15 is a diagram showing an example of a state in which calling for the host vehicle V1 in FIG. 13 is completed;

FIG. 16 is a diagram showing an example in which a user U1 drives the host vehicle V1 and parks the host vehicle V1 in a parking space different from the previous parking space;

FIG. 17 is a diagram showing an example of generating the exit route for the host vehicle V1;

FIG. 18 is a diagram showing an example of calling when the host vehicle V1 is parked in the parking space different from the previous parking space;

FIG. 19 is a diagram showing an example of update of an exit route 80 shown in FIG. 17;

FIG. 20 is a diagram showing an example of a state in which the calling for the host vehicle V1 in FIG. 18 is completed;

FIG. 21 is a flowchart showing a first modification of the movement control by the control ECU 20 when the vehicle 10 enters a garage;

FIG. 22 is a diagram showing an example of a notification that calling is possible and reception of a calling execution instruction;

FIG. 23 is a flowchart showing a second modification of the movement control by the control ECU 20 when the vehicle 10 enters a garage; and

FIG. 24 is a diagram showing an example of a notification to prompt parking at another parking position.

### DESCRIPTION OF EMBODIMENTS

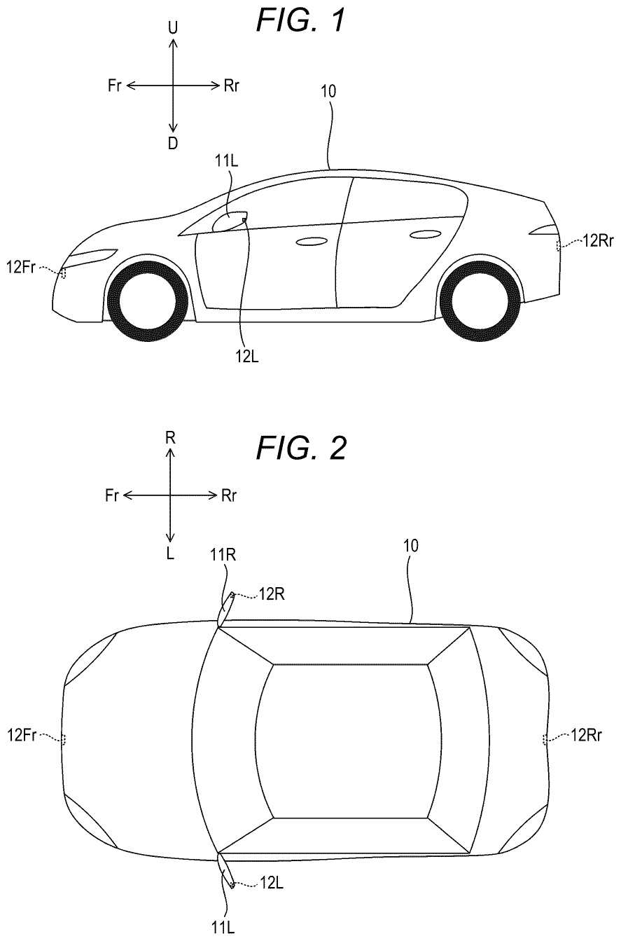

Hereinafter, an embodiment of a control device, a control method, and a storage medium storing a control program in the present disclosure will be described with reference to the accompanying drawings. Note that the drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown 30 as D.

### Vehicle 10 Equipped with Control Device

FIG. 1 is a side view of an example of the vehicle 10 equipped with a control device in the present disclosure. FIG. 2 is a top view of the vehicle 10 shown in FIG. 1. The vehicle 10 is an example of a “moving object” in the present disclosure.

The vehicle 10 is an automobile including a drive source (not shown) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

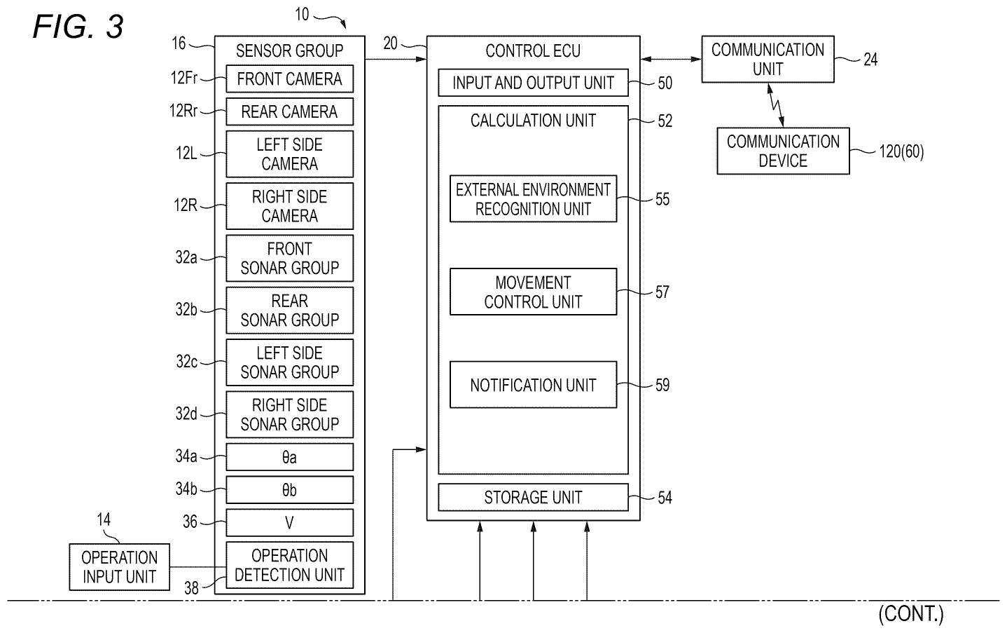

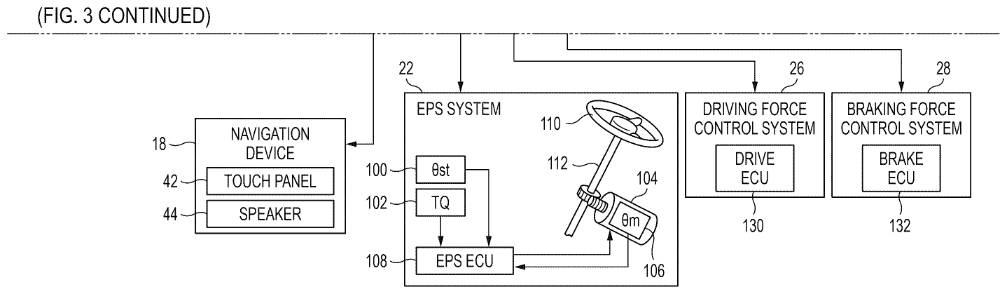

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire external environment recognition data (for example, peripheral images) for recognizing an external environment of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining captured images from the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a route to a destination. The navigation device 18 includes a storage device (not shown) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a remote parking button for requesting parking by automatic steering of the control ECU 20, and a support parking button for requesting support while parking the vehicle by an operation of the user. The exiting assistance button includes a remote exiting button for requesting exiting by the automatic steering of the control ECU 20, and a support exiting button for requesting support while exiting by an operation of the user. Note that a constituent element other than the touch panel 42, for example, an information terminal such as a smartphone or a tablet may be used as the input device or the display device.

Note that the “parking” is synonymous with, for example, “parking”. The “parking” is, for example, a stop as an occupant gets on or off the vehicle, and excludes a temporary stop due to a traffic signal or the like. Further, a “parking position” is a position where the moving object (vehicle 10) is stopped, that is, a parking position.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 receives and outputs signals from and to units connected to the control ECU 20 via the input and output unit 50. The control ECU 20 is an example of a “control device” in the present disclosure.

The storage unit 54 also stores information related to remote movement of the vehicle 10. The storage unit 54 stores, for example, route information related to a movement route when the vehicle 10 moves from an entry start position to a stop position. The stop position refers to a parking position of the vehicle 10, and will hereinafter be referred to as a parking position. Moving to the parking position means moving to the parking position by driving (which may be driving with movement assistance) of the user. The entry start position refers to a position of the vehicle 10 when the user starts parking, and includes, for example, a position of the vehicle 10 when the user presses the parking assistance button to activate a parking assistance function, a position of the vehicle 10 when the vehicle 10 enters a predetermined parking lot area, and a position of the vehicle 10 when the vehicle 10 arrives near a destination indicated by the navigation device 18. The route information includes route data indicating the movement route, parking position data indicating the parking position, and peripheral environment data indicating a feature of a peripheral environment of the movement route and the parking position based on the external environment recognition data.

The calculation unit 52 includes an external environment recognition unit 55 that recognizes an external environment recognition image of the vehicle 10, a movement control unit 57 that controls the remote movement of the vehicle 10, and a notification unit 59 that notifies movement information of the vehicle 10.

The external environment recognition unit 55 acquires the external environment recognition data indicating external environment recognition results of the vehicle 10 captured by the front camera 12Fr, the rear camera 12Rr, the left side camera 12L, and the right side camera 12R from the cameras.

The movement control unit 57 performs remote parking assistance and remote exiting assistance of the vehicle 10 through automatic steering in which a steering 110 is automatically operated under control of the movement control unit 57. In the remote parking assistance and the remote exiting assistance, an accelerator pedal (not shown), a brake pedal (not shown), and the operation input unit 14 are automatically operated. The movement control unit 57 performs support parking assistance and support exiting assistance when the user (driver) operates the accelerator pedal, the brake pedal, and the operation input unit 14 to perform manual parking and manual exiting of the vehicle 10. Note that during the remote parking assistance and the remote exiting assistance, the user may be in a state of being present in the vehicle 10, or may be in a state of getting off the vehicle 10 and being outside (not being present in the vehicle).

For example, the movement control unit 57 performs the movement control for executing movement of the vehicle 10 based on the external environment recognition data of the vehicle 10 acquired by the front camera 12Fr, the rear camera 12Rr, the left side camera 12L, and the right side camera 12R, and a predetermined parking space specified by the user. The movement control includes parking control for remotely parking the vehicle 10 in a predetermined parking space (parking position) and exiting control for remotely causing the vehicle 10 to exit from a parking space to a predetermined target position (exit position). The movement control unit 57 may execute the parking control and the exiting control according to an instruction signal input via the input and output unit 50. The input instruction signal includes an instruction signal transmitted by wireless communication from an information terminal or the like that is portable by the user of the vehicle 10. The movement control unit 57 may transmit information related to the parking control and the exiting control to the information terminal or the like via the input and output unit 50. The movement control is control for moving the vehicle 10 based on an instruction from the information terminal or the like carried by the user of the vehicle 10.

Specifically, the movement control unit 57 performs movement control for moving the vehicle 10 to the exit position based on the external environment recognition data acquired by the cameras and the like and the route information stored in the storage unit 54. The exit position is a target position for calling, and may be, for example, the same position as the entry start position or a position different from the entry start position. The position different from the entry start position may be, for example, an entrance or exit of a facility used by the user.

When it is detected that the vehicle 10 is stopped at a first parking position identical to the parking position indicated by the parking position data in the route information, the movement control unit 57 performs first generation of an exit route from the first parking position to the exit position based on the route data and the parking position data in the route information. When it is detected that the vehicle 10 is stopped at a second parking position different from the parking position indicated by the parking position data in the route information, the movement control unit 57 performs second generation of an exit route from the second parking position to the exit position based on the route data and the peripheral environment data in the route information. The identical first parking position does not necessarily mean that the vehicle is stopped at the exact same position, but may be stopped within a frame of the same parking space, for example. When it is detected that the vehicle 10 is stopped, it means that, for example, it is detected that the vehicle 10 is stopped at a parking position by driving of the user, or it is detected that the user is intended to park and a parking position is estimated. Based on the parking position data means mainly using the parking position data. However, the peripheral environment data may be used as support data. Based on the peripheral environment data means mainly using the peripheral environment data.

In the second generation when it is detected that the vehicle 10 is stopped at the second parking position different from the parking position indicated by the parking position data, the movement control unit 57 estimates a position of the vehicle 10 by host position estimation based on the peripheral environment data acquired by the cameras or the like, and generates the exit route from the estimated position of the vehicle 10 to the exit position that merges with a route corresponding to the movement route indicated by the route data. The route corresponding to the movement route is a route that traces back a movement route taken by the user when driving the vehicle to enter the position. The host position estimation involves comparing a feature (peripheral environment data) detected in the current external environment recognition data with a feature (peripheral environment data) of a registered parking position to recognize a current relative position of the vehicle 10 with respect to the registered parking position.

The movement control unit 57 determines whether the vehicle 10 is stopped at the first parking position based on a comparison between the movement route of the vehicle 10 indicated by the route data stored in the storage unit 54 and the current movement route of the vehicle 10. The movement control unit 57 determines whether the vehicle 10 is stopped at the first parking position based on a comparison between the parking position of the vehicle 10 indicated by the parking position data stored in the storage unit 54 and the current parking position of the vehicle 10.

After the exit route to the exit position is generated by the first generation or the second generation, the movement control unit 57 performs movement control of the vehicle 10 based on the exit route.

The movement control unit 57 performs the first generation or the second generation when the vehicle 10 is stopped at the parking position, and after the exit route to the exit position is generated by the first generation or the second generation, the notification unit 59 notifies the user of the vehicle 10 that movement control is possible from the current position where the vehicle 10 is parked to the exit position (target position for calling), and the generated exit route is stored in the storage unit 54. The vehicle 10 is stopped means that, for example, the vehicle 10 is stopped at the parking position by driving of the user, or it is detected that the user is intended to park and the parking position is estimated.

When a user calls for the vehicle 10 and the movement control unit 57 performs movement control of the vehicle 10 based on the exit route stored in the storage unit 54, the movement control unit 57 updates the exit route based on current external environment recognition data acquired by the cameras and the like, and performs the movement control of the vehicle 10 based on the updated exit route. The update is not performed unless there is a significant change in the external environment recognition data.

After notifying the user of the vehicle 10 that the movement control of the vehicle 10 based on the exit route is possible, the movement control unit 57 stores the exit route in the storage unit 54 when receiving an instruction to execute the movement control based on the exit route from the user. Receiving an instruction from the user may mean, for example, receiving the instruction via the navigation device 18 of the vehicle 10, or receiving the instruction via an information terminal of the user. The movement control unit 57 performs the movement control of the vehicle 10 based on the exit route, according to the instruction from the user of the vehicle 10. Note that if there is no instruction from the user, the exit route is not stored, and the movement control based on the exit route is not executed.

The movement control unit 57 detects the stop of the vehicle 10 at the second parking position, and if the second generation fails to generate the exit route to the exit position, the notification unit 59 performs a notification prompting the vehicle 10 to stop at the first parking position.

For example, if the parking position where the user stops the vehicle 10 is one where the vehicle 10 can be moved to the exit position by the movement control unit 57, the notification unit 59 notifies the user of the vehicle 10 the above matter. The notification may be performed by, for example, using the navigation device 18 of the vehicle 10, or transmitting information to the information terminal of the user. If the second generation of the movement control unit 57 fails to generate the exit route to the exit position, the notification unit 59 may notify that movement control based on the exit route is not possible from the current parking position where the vehicle 10 is stopped.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an operation of an occupant on the steering 110 and automatic steering during the parking assistance. The resolver 106 detects a rotation angle Om of the EPS motor 104. The EPS ECU 108 controls the entire EPS system 22. The EPS ECU 108 includes an input and output unit (not shown), a calculation unit (not shown), and a storage unit (not shown).

The communication unit 24 enables wireless communication with another communication device 120. Another communication device 120 includes a base station, a communication device of another vehicle, an information terminal 60 such as a smartphone or a tablet that is portable for the user of the vehicle 10, and the like. For example, the communication unit 24 includes an ultra wide band (UWB, registered trademark) interface or the like that can execute UWB communication with the information terminal 60.

The driving force control system 26 includes a drive ECU 130. The driving force control system 26 executes driving force control of the vehicle 10. The drive ECU 130 controls a driving force of the vehicle 10 by controlling an engine (not shown) or the like based on an operation performed by the user on the accelerator pedal (not shown).

The braking force control system 28 includes a brake ECU 132. The braking force control system 28 executes braking force control of the vehicle 10. The brake ECU 132 controls a braking force of the vehicle 10 by controlling a brake mechanism or the like (not shown) based on an operation performed by the user on the brake pedal (not shown).

### Hardware Configuration of Information Terminal 60 of User

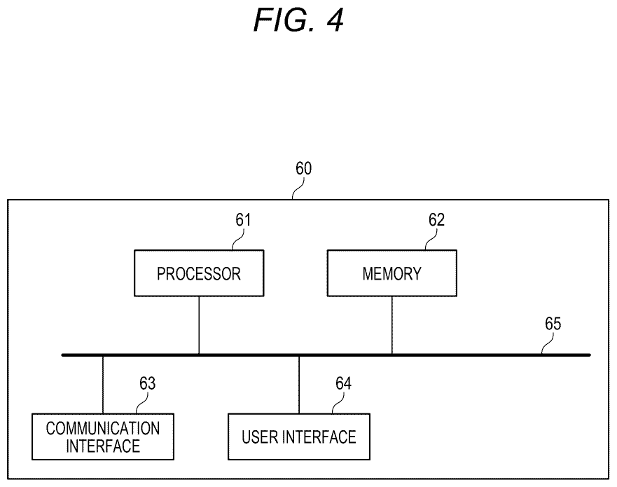

FIG. 4 is a diagram showing an example of a hardware configuration of the information terminal 60 owned by the user of the vehicle 10. The information terminal 60 includes a processor 61, a memory 62, a communication interface 63, and a user interface 64. The processor 61, the memory 62, the communication interface 63, and the user interface 64 are connected by, for example, a bus 65.

The processor 61 is a circuit that executes signal processing, and is, for example, a central processing unit (CPU) that controls the entire information terminal 60. Note that the processor 61 may be implemented by another digital circuit such as a field programmable gate array (FPGA) or a digital signal processor (DSP). The processor 61 may also be implemented by combining a plurality of digital circuits.

The memory 62 includes, for example, a main memory and an auxiliary memory. The main memory is, for example, a random access memory (RAM). The main memory is used as a work area of the processor 61.

The auxiliary memory is a non-volatile memory such as a magnetic disk, an optical disk, or a flash memory. The auxiliary memory stores various programs for operating the information terminal 60. The programs stored in the auxiliary memory are loaded into the main memory and executed by the processor 61.

The auxiliary memory may include a portable memory removable from the information terminal 60. Examples of the portable memory include a universal serial bus (USB) flash drive, a memory card such as a secure digital (SD) memory card, and an external hard disk drive.

The communication interface 63 is a communication interface that executes wireless communication with the outside of the information terminal 60 (for example, the communication unit 24 of the vehicle 10). For example, the communication interface 63 includes a UWB interface for executing UWB communication with the vehicle 10. The communication interface 63 is controlled by the processor 61.

The user interface 64 includes, for example, an input device that receives an operation input from the user and an output device that outputs information to the user. The input device may be implemented by, for example, a touch panel. The output device may be implemented by, for example, a display or a speaker. The user interface 64 is controlled by the processor 61.

The processor 61 executes movement control for instructing movement of the vehicle 10. For example, the processor 61 performs the movement control (including the parking control and the exiting control) on the vehicle 10 based on a specific operation of the user on a terminal screen of the information terminal 60. The specific operation includes, for example, a tap operation for instructing parking and exiting (calling) of the vehicle 10, and a slide operation for moving the vehicle 10. The slide operation includes a continuous position instruction operation (for example, swiping operation), a rotation instruction operation in a predetermined rotation direction (for example, rotation swiping operation), and the like. The processor 61 further executes control to generate a guidance image for prompting the user to perform an instruction operation on the terminal screen of the information terminal 60 and display the generated guidance image on the terminal screen.

The processor 61 transmits, to the vehicle 10, a parking instruction for remotely parking the vehicle 10 and an exiting instruction for remotely causing the vehicle 10 to exit based on a specific operation on the terminal screen of the information terminal 60. An application configured to perform movement control (remote parking, remote exiting) on the vehicle 10 by transmitting and receiving information related to the movement control of the vehicle 10 to and from the vehicle 10 is installed in the information terminal 60.

### Example of Control by Control ECU 20

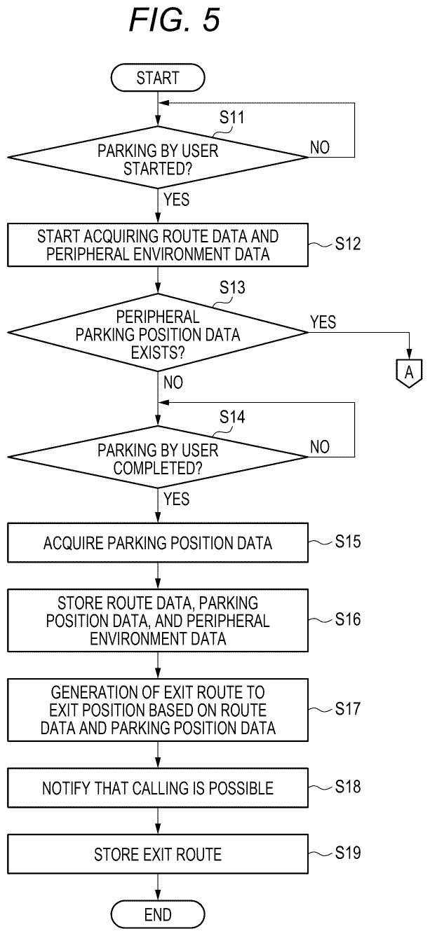

Next, the movement control by the control ECU 20 when the vehicle 10 enters and exits a garage will be described with reference to FIGS. 5 to 7. FIG. 5 is a flowchart (part 1) showing movement control by the control ECU 20 when the vehicle 10 enters a garage.

First, the control ECU 20 determines whether the user starts parking the vehicle 10 (step S11). Parking of the vehicle 10 by the user can be determined to begin, for example, when the user presses a parking assistance button to activate the parking assistance function, when the vehicle 10 enters a predetermined parking lot area, when the vehicle 10 arrives near a destination indicated by the navigation device 18, or the like. Here, the following description will be given on an assumption that the vehicle 10 arrives at a parking lot of a shopping mall and the user presses the parking assistance button.

In step S11, if parking of the vehicle 10 by the user is not started (step S11: No), the control ECU 20 repeats the determination of step S11. In step S11, if the parking of the vehicle 10 by the user is started (step S11: Yes), the control ECU 20 starts acquiring route data indicating a movement route along which the user moves the vehicle 10 to a parking position, and peripheral environment data indicating a feature of a peripheral environment of the movement route and the parking position of the vehicle 10 (step S12).

Next, the control ECU 20 determines whether currently there is peripheral parking position data near a parking lot where the user is intended to park the vehicle 10 (step S13). The peripheral parking position data is, for example, parking position data of the same parking lot as the current parking lot. That is, it is determined whether the user has used this parking lot before. The peripheral parking position data may also be, for example, parking position data close to the current parking position of the vehicle 10, parking position data with the same destination as the current parking lot, or parking position data in the same area.

In step S13, if there is no peripheral parking position data (step S13: No), the control ECU 20 determines whether the parking of the vehicle 10 by the user started in step S11 is completed (step S14). The case where there is no peripheral parking position data means that the parking lot of the shopping mall is a parking lot that the user has never visited before.

In step S14, if the parking of the vehicle 10 by the user is not completed (step S14: No), the control ECU 20 repeats the determination of step S14 until the parking of the vehicle 10 is completed. In step S14, if the parking of the vehicle 10 by the user is completed (step S14: Yes), the control ECU 20 acquires parking position data indicating the current parking position of the vehicle 10 based on the external environment recognition data (step S15).

Next, the control ECU 20 stores the route data and the peripheral environment data acquired in step S12 and the parking position data acquired in step S15 in the storage unit 54 (step S16).

Next, the control ECU 20 generates an exit route from the current parking position of the vehicle 10 to the exit position to which the vehicle 10 is called, based on the route data and the parking position data stored in step S16 (step S17).

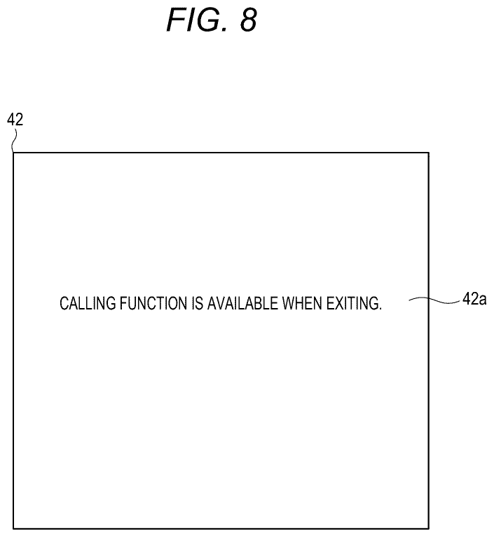

Next, the control ECU 20 notifies the user that the current parking position where the vehicle 10 is parked is a parking position where the vehicle 10 can be called to the exit position (step S18). The notification may be performed by, for example, using the navigation device 18, or transmitting information to the information terminal 60 of the user. This notification will be described later with reference to FIG. 8.

Next, the control ECU 20 stores the exit route to the exit position generated in step S17 in the storage unit 54 (step S19).

Note that in the above processing, the control ECU 20 starts acquiring the route data and the peripheral environment data in response to the start of parking by the user as a trigger, but the present disclosure is not limited thereto. For example, the control ECU 20 may constantly acquire the route data and the peripheral environment data, and when parking is completed, use the completion of parking as a trigger to store only the route data and the peripheral environment data acquired immediately before the parking completion.

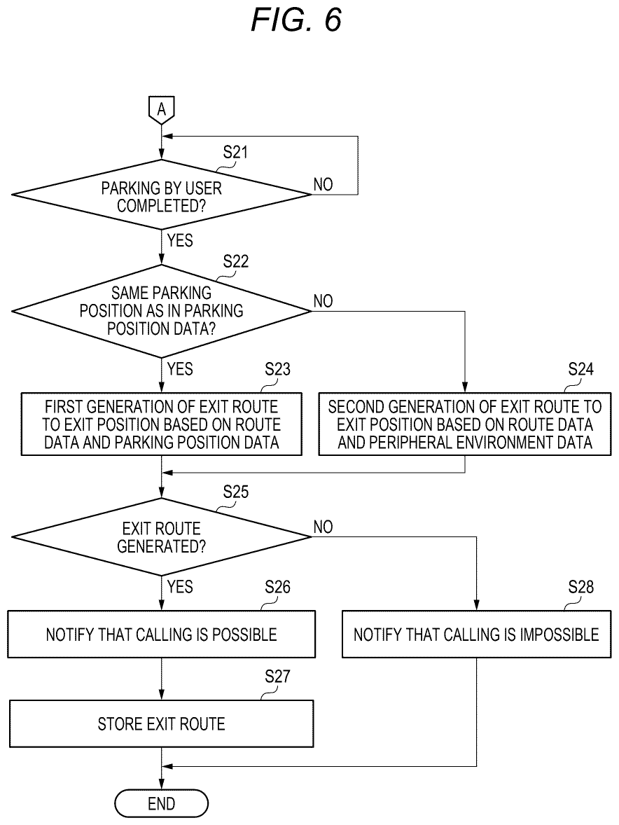

On the other hand, in step S13, if there is peripheral parking position data (step S13: Yes), the control ECU 20 proceeds to the processing shown in FIG. 6. FIG. 6 is a flowchart (part 2) showing the movement control of the control ECU 20 when the vehicle 10 enters a garage.

The control ECU 20 determines whether the parking of the vehicle 10 by the user started in step S11 is completed (step S21). Note that the determination in step S21 may be, for example, whether it is detected that the user is intended to park the vehicle 10 and whether the parking position is estimated.

In step S21, if the parking of the vehicle 10 by the user is not completed (step S21: No), the control ECU 20 repeats the determination of step S21 until the parking of the vehicle 10 is completed. In step S21, if the parking of the vehicle 10 by the user is completed (step S21: Yes), the control ECU 20 determines whether the parking position where the user parks the vehicle 10 is a parking position same as the parking position in the peripheral parking position data determined to exist in step S13 (step S22). That is, it is determined whether the user is intended to park the vehicle 10 in the same parking position in the parking lot of the shopping mall that the user visited before.

In step S22, if the parking position is the same as that in the parking position data (step S22: Yes), the control ECU 20 performs the first generation to generate an exit route from the parking position to the exit position based on the route data acquired in step S12 and the peripheral parking position data determined to exist in step S13 (step S23). Note that under this case, the first generation may be performed after acquiring the peripheral environment data during the parking of this time and taking the peripheral environment into consideration. When the stored data of the previous exit route can be used, that exit route may be used.

On the other hand, in step S22, if the parking position is not the same as that in the parking position data (step S22: No), the control ECU 20 performs the second generation to generate an exit route from the parking position to the exit position based on the route data and the peripheral environment data acquired in step S12 (step S24). Specifically, the current parking position is estimated based on the feature of the peripheral environment data, and the exit route from the parking position to the exit position that merges with a route that traces back the movement route at the time of entry as indicated by the route data is generated. Note that the control ECU 20 may store the route data, the parking position data, and the peripheral environment data of the parking of this time in the storage unit 54.

Next, the control ECU 20 determines whether the exit route to the exit position is generated in the processing of step S23 or step S24 (step S25).

In step S25, if the exit route is generated (step S25: Yes), the control ECU 20 notifies the user that the current parking position where the vehicle 10 is parked is a parking position from which the vehicle 10 can be called to the exit position (step S26). This notification will be described later with reference to FIG. 8.

Next, the control ECU 20 stores the exit route to the exit position generated in step S23 or step S24 in the storage unit 54 (step S27).

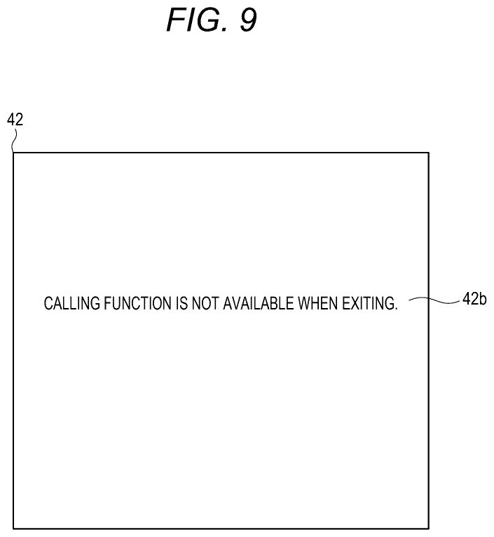

On the other hand, in step S25, if the exit route is not generated (step S25: No), the control ECU 20 notifies the user that the current parking position where the vehicle 10 is parked is a parking position from which the vehicle 10 cannot be called to the exit position (step S28). This notification will be described later with reference to FIG. 9. Note that if the exit route is not generated, the processing ends without storing any exit route.

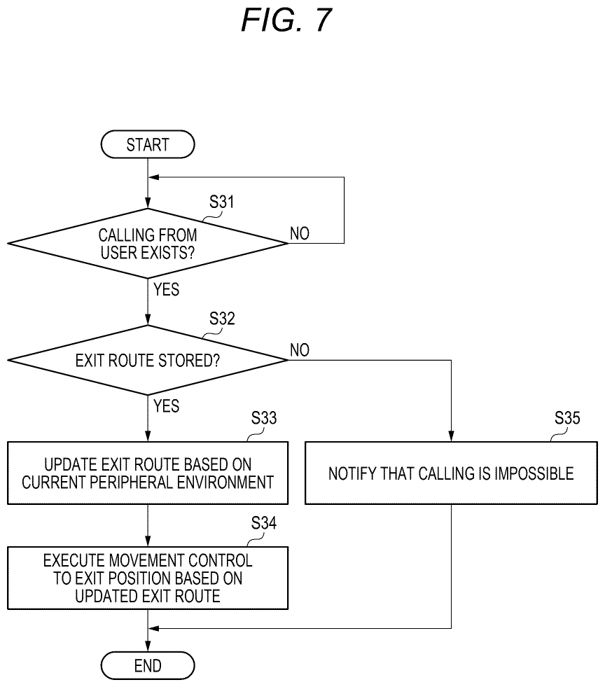

FIG. 7 is a flowchart showing movement control of the control ECU 20 when the vehicle 10 exits a garage.

The control ECU 20 determines whether the user calls for the vehicle 10 (step S31). Calling from the user is based on, for example, a specific operation on the information terminal 60 by the user, and is reception of calling (exit) instruction signal from the information terminal 60.

In step S31, if there is no calling from the user (step S31: No), the control ECU 20 repeats the determination of step S31. In step S31, if there is calling from the user (step S31: Yes), the control ECU 20 determines whether the exit route from the parking position of the vehicle 10 to the exit position corresponding to the calling instruction signal from the information terminal 60 is stored in the storage unit 54 (step S32).

In step S32, if the exit route is stored (step S32: Yes), the control ECU 20 updates the exit route to the exit position of the vehicle 10 based on the current peripheral environment on the basis of the external environment recognition data (step S33).

Next, the control ECU 20 executes the movement control of the vehicle 10 to the exit position called by the user, based on the exit route updated in step S33 (step S34).

On the other hand, in step S32, if the exit route is not stored (step S32: No), the control ECU 20 notifies the user that the vehicle 10 cannot be called (step S35). This notification will be described later with reference to FIG. 9.

### Notification Screen

Next, notification about whether the vehicle 10 can be called will be described.

FIG. 8 is a diagram showing an example of a notification that calling is possible. As shown in FIG. 8, the notification that calling is possible is displayed on the touch panel 42 of the navigation device 18, for example. The touch panel 42 displays a message 42a informing that the parking position where the user parks the vehicle 10 is a position where the vehicle 10 can be called to the exit position when exiting the garage, such as “Calling function is available when exiting”. This message 42a is, for example, a message notified in step S18 in FIG. 5 and step S26 in FIG. 6. Note that in this example, the message 42a is displayed on the navigation device 18, but the present disclosure is not limited thereto, and for example, the message 42a may be displayed on the information terminal 60 of the user.

FIG. 9 is a diagram showing an example of a notification that calling is impossible. As shown in FIG. 9, the notification that calling is impossible is displayed on the touch panel 42 of the navigation device 18, for example. The touch panel 42 displays a message 42b informing that the parking position where the user parks the vehicle 10 is a position where the vehicle 10 cannot be called to the exit position when exiting the garage, such as “Calling function is not available when exiting.” This message 42b is, for example, a message notified in step S28 in FIG. 6 and step S35 in FIG. 7. The message notified in step S35 in FIG. 7 may be, for example, “Calling function is not available since exiting data is not stored.” Note that in this example, the message 42b is displayed on the navigation device 18, but the present disclosure is not limited thereto, and for example, the message 42b may be displayed on the information terminal 60 of the user.

### Remote Exiting Operation

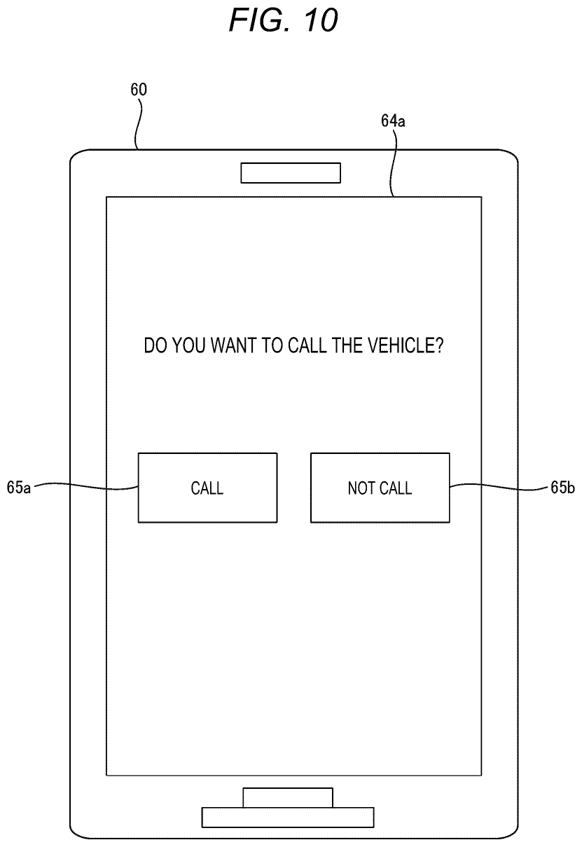

Next, an operation for calling the vehicle 10 to the exit position will be described. FIG. 10 is a diagram showing an example of a remote exiting screen displayed on the information terminal 60. As shown in FIG. 10, when an application for remotely causing the vehicle 10 to exit installed in the information terminal 60 is activated, a remote exiting screen 64a capable of calling the vehicle 10 is displayed on the information terminal 60. The remote exiting screen 64a displays a message such as “Do you want to call the vehicle?” along with a “Call” button 65a and a “Not call” button 65b for selecting whether to call. When this “Call” button 65a is pressed, the determination of “whether user calls?” in step S31 in FIG. 7 becomes “Yes”.

### Entry and Exit if Vehicle in Parking Lot

Next, the entry and exit of the vehicle based on the movement control of the control ECU 20 will be described with reference to FIG. 11 to FIG. 20. FIG. 11 is a diagram showing an example of a parking lot where the user causes the vehicle to enter and exit. As shown in FIG. 11, a user driving a host vehicle V1 arrives at a parking lot 70 of a shopping mall. A plurality of other vehicles V2 are parked in the parking lot 70. A pedestrian M (obstacle) walks in the parking lot 70. The user is intended to the host vehicle V1 in a parking space in the parking lot 70.

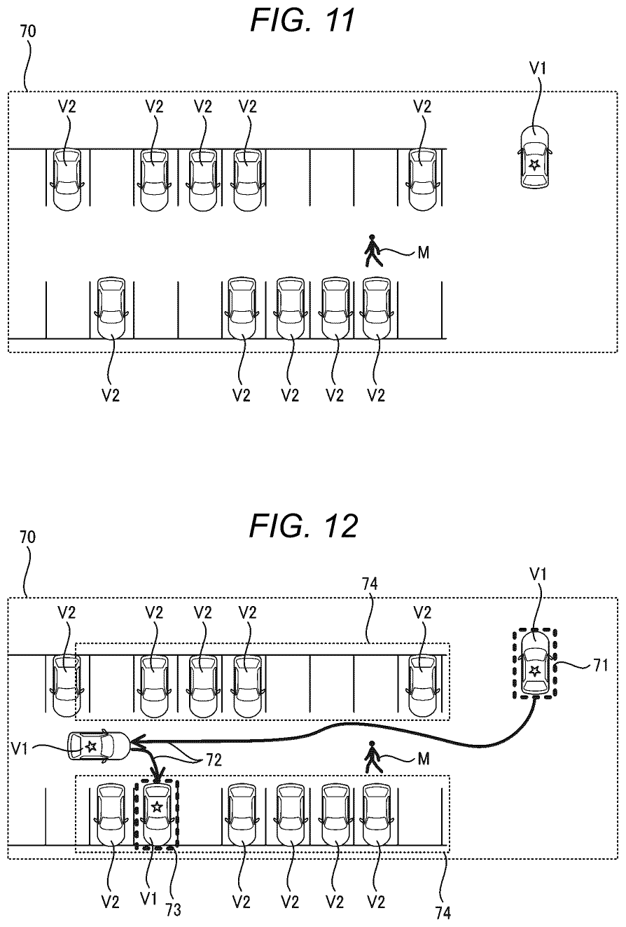

FIG. 12 is a diagram showing an example of the user driving the host vehicle V1 to park the host vehicle V1 in a parking space in the parking lot 70. For example, it is assumed that the user presses a parking assistance button to activate a parking assistance function at a position of the host vehicle V1 shown in FIG. 12. The position at the time when this parking assistance button is pressed is an entry start position 71 of the host vehicle V1, which is, for example, a position of the host vehicle V1 at the time when the determination of “parking by user started?” in step S11 in FIG. 5 becomes Yes. The user moves the host vehicle V1 along a movement route 72 indicated by a solid arrow, and parks the host vehicle V1 in, for example, a first parking position 73 in the parking lot 70.

In this case, the control ECU 20 acquires route data, parking position data, and peripheral environment data when the vehicle 10 moves from the entry start position 71 to the first parking position 73. The route data is data of the movement route 72. The parking position data is data of the first parking position 73. The peripheral environment data is data that indicates a feature of a peripheral environment 74 of the movement route 72 and the first parking position 73. In this example, the feature of the peripheral environment 74 includes parking areas (areas surrounded by dotted lines) around the movement route 72 and the first parking position 73, vacant parking spaces and occupied parking spaces in the parking areas, presence or absence of obstacles and positions of the obstacles, and the like. The movement route 72 becomes a curved route in an area where the pedestrian M is present to avoid the pedestrian M. These processing steps correspond to, for example, step S12 and step S15 in FIG. 5.

FIG. 13 is a diagram showing an example in which the user calls the host vehicle V1 parked in the parking lot 70. As shown in FIG. 13, a user U1 activates a remote exiting application on the information terminal 60 and performs a specific operation to call the host vehicle V1. Specifically, the user U1 parks the host vehicle V1 in the first parking position 73 as described with reference to FIG. 12, and then calls the host vehicle V1 after finishing shopping at the shopping mall, for example. Note that in this example, the calling position of the user U1 is near the entry start position 71, but the present disclosure is not limited thereto. When the peripheral environment data at the time of this calling is compared with the peripheral environment data when the host vehicle V1 is parked as described with reference to FIG. 12, it is found that the pedestrian M is no longer present in the parking lot 70. The time when this calling operation is performed is, for example, the time when the determination of “whether user calls?” in step S31 in FIG. 7 becomes Yes.

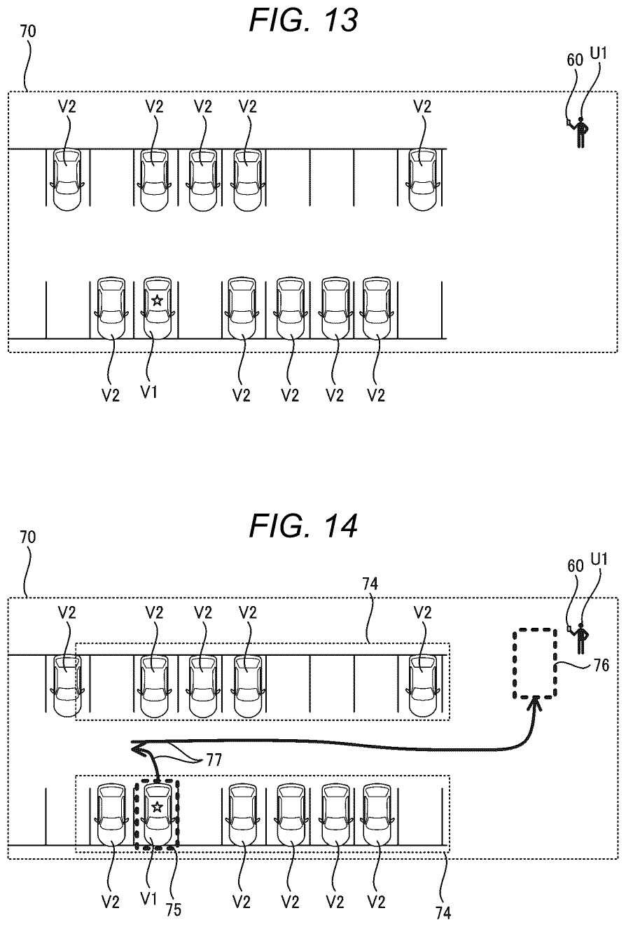

FIG. 14 is a diagram showing an example of update of the exit route of the host vehicle V1. As described in FIG. 13, when the host vehicle V1 is called, the control ECU 20 determines whether an exit route from a parking position 75 of the host vehicle V1 to an exit position 76 where the host vehicle V1 is called, which corresponds to a calling instruction signal from the user U1 (information terminal 60), is stored in the storage unit 54. In this example, the parking position 75 of the host vehicle V1 is the same as the first parking position 73 where the host vehicle V1 is parked in FIG. 12, and therefore the exit route to the exit position 76 is stored. When it is determined that the corresponding exit route is stored, the control ECU 20 acquires current external environment recognition data and determines whether there is a significant difference between the acquired current external environment recognition data and the external environment recognition data used in generating the stored exit route. A significant difference between the two pieces of external environment recognition data is, for example, a difference that affects an optimal exit route. As an example, whether there is a significant difference between the two pieces of external environment recognition data is determined based on a difference in presence or absence of obstacles around the current exit route 77. However, the presence or absence of a significant difference between the two pieces of external environment recognition data can be determined by various methods other than the above one. For example, if a sum of differences (absolute values) between two pieces of external environment recognition data exceeds a threshold, it may be determined that there is a significant difference between the two pieces of external environment recognition data. If it is determined that there is a significant difference, the control ECU 20 generates an exit route 77 from the parking position 75 to the exit position 76 based on the peripheral environment on the basis of the current external environment recognition data, and updates the exit route stored in the storage unit 54 to the exit route 77. The updated exit route 77 shown in FIG. 14 is compared with the exit route generated at the time of entry in FIG. 12, and since there is no pedestrian M on the exit route, the exit route is changed accordingly (from curved to straight).

Note that in this example, the exit position 76 of the host vehicle V1 called by the user U1 is near the entry start position 71, but may be a different position. In the case of a different position, the exit route is updated to a route having a common part which is the same as the exit route 77 shown in FIG. 14, and a different part which becomes the exit route generated based on the current external environment recognition data.

FIG. 15 is a diagram showing an example of a state in which calling for the host vehicle V1 in FIG. 13 is completed. As shown in FIG. 15, the host vehicle V1 moves to the exit position 76 called by the user U1, following, for example, the exit route 77 generated in FIG. 14.

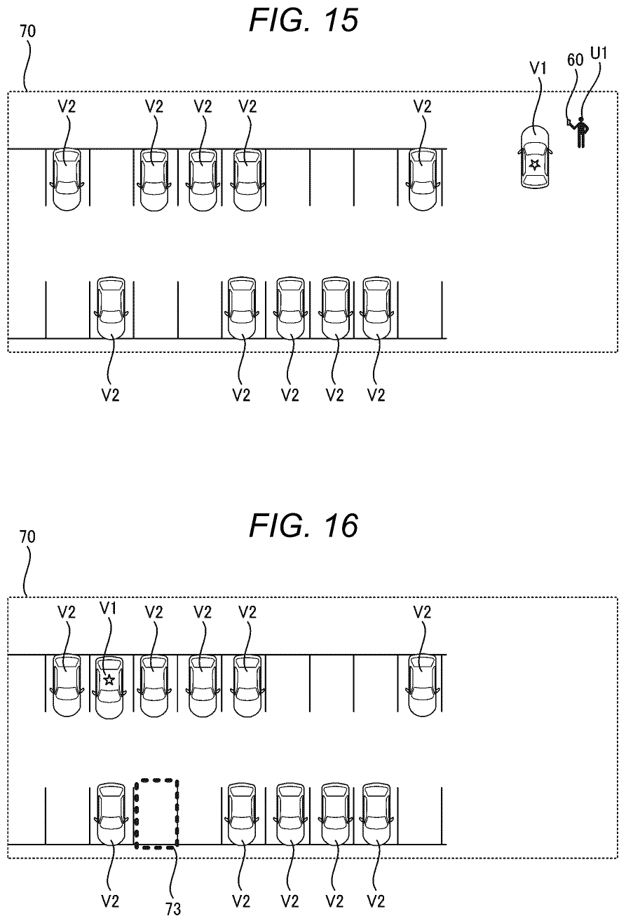

FIG. 16 is a diagram showing an example in which the user U1 drives the host vehicle V1 and parks the host vehicle V1 in a parking space different from the previous parking space. For example, it is assumed that the user U1 visits the same shopping mall at a later date and parks the host vehicle V1 in a parking space in the parking lot 70 that is different from the first parking position 73 used previously.

FIG. 17 is a diagram showing an example of generating the exit route for the host vehicle V1. As shown in FIG. 17, the parking space where the user U1 parks the host vehicle V1 is a second parking position 78 in the parking lot 70. This second parking position 78 is a parking space different from the first parking position 73 in the parking lot 70 where the user U1 parks the host vehicle V1 at the previous time he or she visits the same shopping mall, but it is a parking space in the same peripheral environment 74 as the previous time.

In this case, the parking position data when the host vehicle V1 is parked at the first parking position 73 of the parking lot 70 is stored as previous parking position data. The current second parking position 78 is different from the first parking position 73 in the stored parking position data. For this reason, the control ECU 20 estimates the current parking position (second parking position 78) based on the feature of the peripheral environment data, and generates an exit route 80 (solid arrow) from the second parking position 78 to the exit position 76, which merges with a movement route 79 (dashed arrow) that traces back the movement route 72 (see FIG. 12) at the time of entry indicated by the previous route data. These processing steps correspond to, for example, step S13 in FIG. 5 to steps S21, S22, and S24 in FIG. 6.

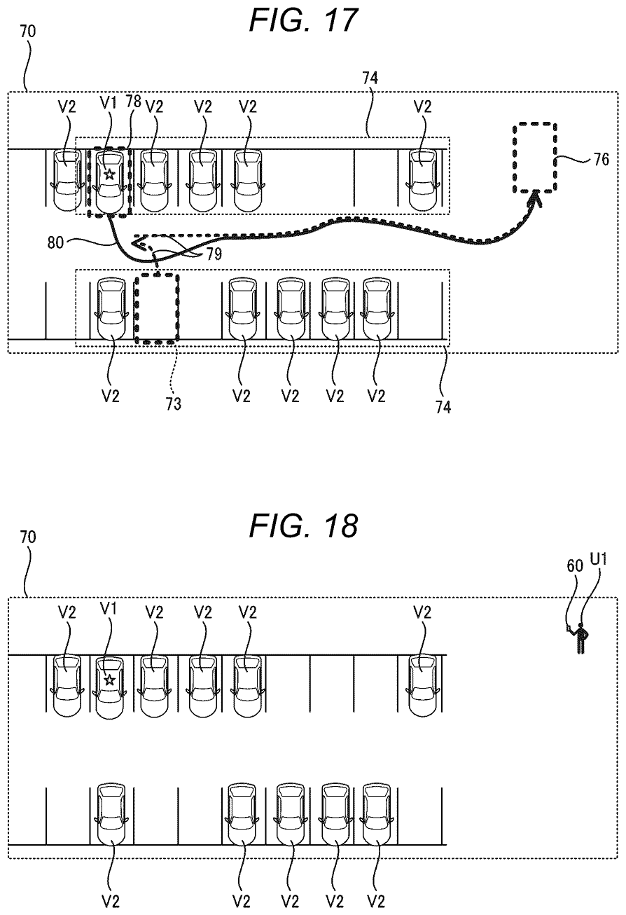

FIG. 18 is a diagram showing an example of calling when the host vehicle V1 is parked in the parking space different from the previous parking space. As shown in FIG. 18, the user U1 parks the host vehicle V1 in the second parking position 78 (see FIG. 17) and then, after finishing shopping at the shopping mall, for example, calls for the host vehicle V1 near the entry start position 71 (see FIG. 12). Note that the time when this calling operation is performed is, for example, the time when the determination of “whether user calls?” in step S31 in FIG. 7 becomes Yes.

FIG. 19 is a diagram showing an example of update of the exit route 80 shown in FIG. 17. As described in FIG. 18, when the host vehicle V1 is called, the control ECU 20 determines whether an exit route from the second parking position 78 of the host vehicle V1 to the exit position 76 where the host vehicle V1 is called, which corresponds to a calling instruction signal from the user U1 (information terminal 60), is stored in the storage unit 54. Note that in this example, the exit route from the second parking position 78 is stored as the exit route 80 from the second parking position 78 to the exit position 76 generated in FIG. 17. The control ECU 20 acquires current external environment recognition data and determines whether there is a significant difference between the acquired current external environment recognition data and the external environment recognition data used in generating the stored exit route. If it is determined that there is a significant difference, the control ECU 20 generates an exit route 81 from the second parking position 78 to the exit position 76 based on the peripheral environment on the basis of the current external environment recognition data, and updates the exit route stored in the storage unit 54 to the exit route 81. The updated exit route 81 shown in FIG. 19 is a straight, not curved exit route 81 since there are no obstacles on the way of the exit route compared with the exit route 80 in FIG. 17.

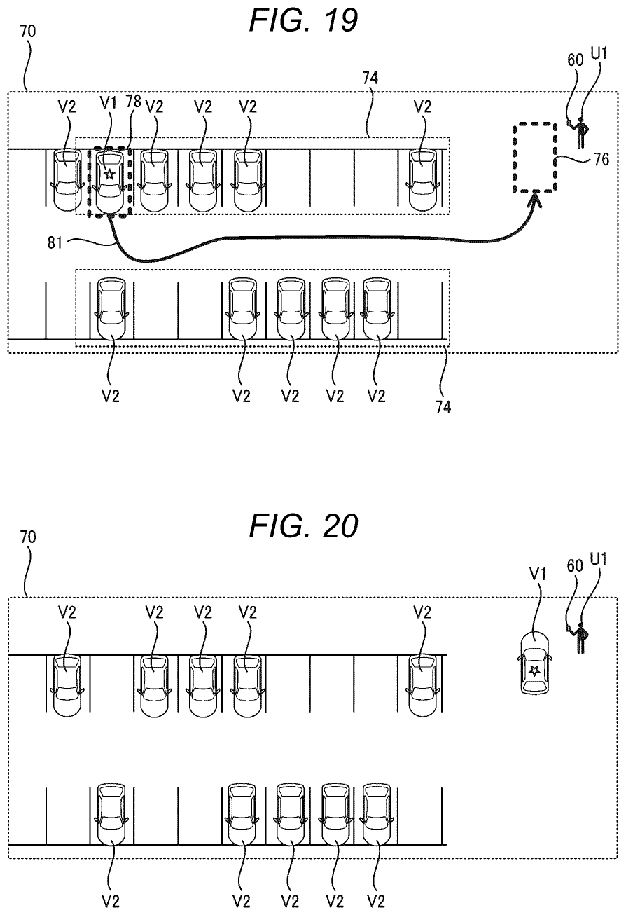

FIG. 20 is a diagram showing an example of a state in which calling for the host vehicle V1 in FIG. 18 is completed. As shown in FIG. 20, the host vehicle V1 moves to the exit position 76 called by the user U1, following, for example, the exit route 81 generated in FIG. 19.

As described above, when the user U1 parks the host vehicle V1 (vehicle 10) in the first parking position 73 of the parking lot 70 at the previous time and parks the host vehicle

V1 in the same first parking position 73 this time as well, the control ECU 20 of the present embodiment performs the first generation of the exit route 77 from the first parking position 73 to the exit position 76 based on the first parking position 73 and the movement route 72 of the host vehicle V1 at the previous time the host vehicle V1 is parked at the first parking position 73. On the other hand, when the host vehicle V1 is parked this time at the second parking position 78 different from the first parking position 73, the control ECU 20 performs the second generation of the exit route 81 from the second parking position 78 to the exit position 76 based on the peripheral environment data of the second parking position 78 and the previous movement route 72 of the host vehicle V1. Therefore, even when the host vehicle V1 is parked at a position different from the previous one, there is no need to store route information regarding the movement route when parking each time the vehicle is parked, and the previous movement route can be used to generate an exit route to the exit position, so that movement control for causing the host vehicle V1 to exit to the exit position can be flexibly performed.

When the host vehicle V1 is parked at the second parking position 78 different from the previous first parking position 73, the control ECU 20 estimates the second parking position 78 in terms of a positional relation thereof with the first parking position 73 from the peripheral environment data of the host vehicle V1 at the current second parking position 78, and generates the exit route 80 from the estimated second parking position 78 to the exit position 76 which merges with the movement route 79 that traces back the movement route 72 used during the previous entry. Therefore, movement control for causing the host vehicle V1 to exit to the exit position 76 can be flexibly performed using the previous movement route 72.

When the host vehicle V1 is parked at a parking position (first parking position 73, second parking position 78), the control ECU 20 performs generation (first generation, second generation) of an exit route from the parking position to the exit position 76, and if it is possible to call the host vehicle V1 to the exit position 76, the control ECU 20 notifies the user U1 of that when the host vehicle V1 is parked. In this way, the user U1 can know whether the host vehicle V1 can be called at the time when the parking of the host vehicle V1 is completed, thereby improving usability regarding calling the host vehicle V1 to the exit position 76.

### First Modification of Control by Control ECU 20

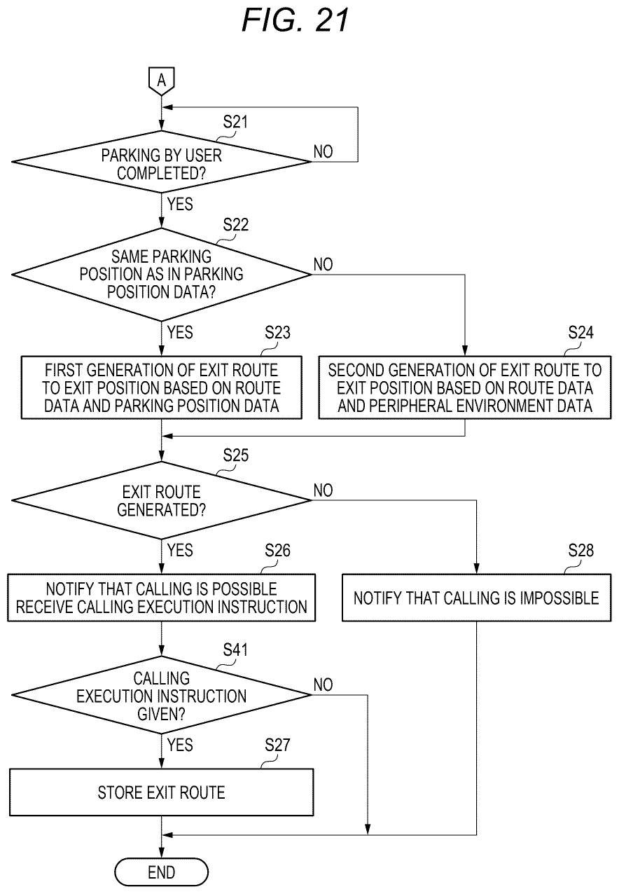

FIG. 21 is a flowchart showing a first modification of the movement control by the control ECU 20 when the vehicle 10 enters a garage. This flowchart corresponds to the processing from step S21 onward in the flowchart of FIG. 6 for the movement control described with reference to FIGS. 5 and 6. As shown in FIG. 21, the processing from step S21 to step S25 and the processing of step S28 are similar to the processing from step S21 to step S25 and the processing of step S28 of the movement control described with reference to FIG. 6.

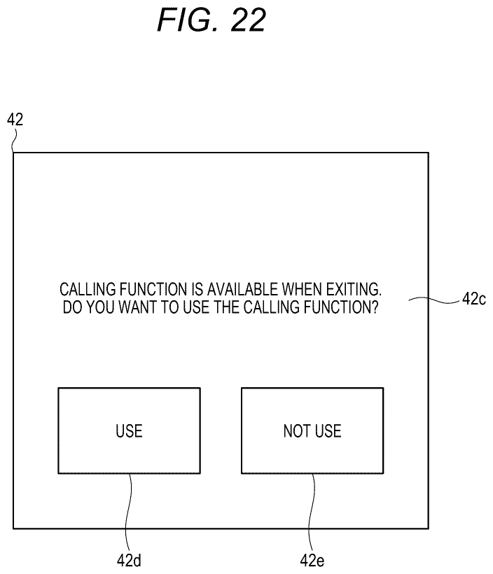

If an exit route is generated in step S25 (step S25: Yes), the control ECU 20 notifies the user that the current parking position where the vehicle 10 is parked is a parking position where the vehicle 10 can be called to the exit position, and receives a calling execution instruction from the user to execute movement control of the vehicle 10 based on the generated exit route (step S26). The reception of the calling execution instruction will be described later with reference to FIG. 22.

Next, the control ECU 20 determines whether a calling execution instruction is given by the user (step S41).

In step S41, if a calling execution instruction is given (step S41: Yes), the control ECU 20 stores the exit route to the exit position generated in step S23 or step S24 in the storage unit 54 (step S27), and then ends this processing. On the other hand, in step S41, if no calling execution instruction is given (step S41: No), the control ECU 20 ends this processing without storing any exit route. Therefore, when there is no calling execution instruction from the user, the movement control based on the exit route generated in step S23 or step S24 is not executed.

### Notification and Reception Screen

FIG. 22 is a diagram showing an example of the notification that calling is possible and the reception of the calling execution instruction. As shown in FIG. 22, the notification that calling is possible and the reception of the calling execution instruction are displayed on the touch panel 42 of the navigation device 18, for example. The touch panel 42 displays a message 42c informing that the parking position where the vehicle 10 is parked is a position where the vehicle 10 can be called to the exit position when exiting the garage, such as “Calling function is available when exiting.”, and informing that an instruction of calling is to be received, such as “Do you want to use the calling function?” In addition, a “Use” button 42d and a “Not use” button 42e for receiving an instruction of calling are displayed on the touch panel 42. This message 42c is, for example, a message notified in step S26 of FIG. 21. Moreover, whether a calling execution instruction is given in step S41 in FIG. 21 depends on whether the “Use” button 42d is pressed. Note that the message 42c and the buttons 42d and 42e may be displayed on the information terminal 60 of the user, for example.

In the first modification, while notifying the user that movement control based on the exit route from the parking position of the vehicle 10 to the exit position is possible, the control ECU 20 receives an instruction from the user as to whether to execute the movement control, and if an instruction to execute is given, the control ECU 20 stores the generated exit route in the storage unit 54. Therefore, if there is no instruction to execute from the user, the exit route is not stored and the movement control based on the exit route is not executed, so that route information regarding the exit route can be processed efficiently.

### Second Modification of Control by Control ECU 20

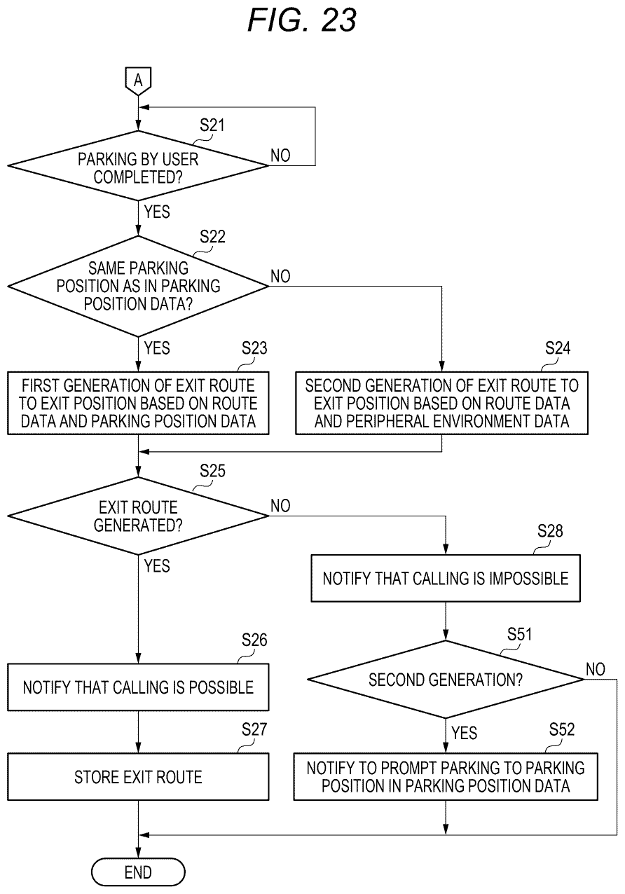

FIG. 23 is a flowchart showing a second modification of the movement control by the control ECU 20 when the vehicle 10 enters a garage. This flowchart corresponds to the processing from step S21 onward in the flowchart of FIG. 6 for the movement control described with reference to FIGS. 5 and 6. As shown in FIG. 23, the processing from step S21 to step S28 are similar to the processing from step S21 to step S28 of the movement control described with reference to FIG. 6.

After notifying in step S28 that calling the vehicle 10 is impossible, the control ECU 20 determines whether what cannot be generated in step S25 is the exit route to be generated by the second generation (step S51).

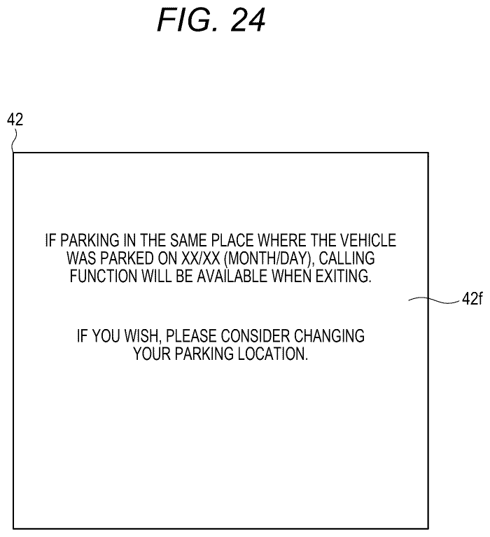

In step S51, if what cannot be generated in step S25 is the exit route to be generated by the second generation (step S51: Yes), the control ECU 20 performs a notification to prompt parking of the vehicle 10 at the parking position in the peripheral parking position data determined to exist in step S13 (see FIG. 5) (step S52). This notification will be described later with reference to FIG. 24. On the other hand, in step S51, if what cannot be generated in step S25 is not the exit route to be generated by the second generation (step S51: No), the control ECU 20 ends this processing.

### Notification Screen

FIG. 24 is a diagram showing an example of the notification to prompt parking at another parking position. As shown in FIG. 24, the notification to prompt parking at another parking position is displayed on, for example, the touch panel 42 of the navigation device 18. The touch panel 42 displays a message 42f informing that calling to the exit position will become possible if the parking position of the vehicle 10 is changed, such as “If parking in the same place where the vehicle was parked on XX/XX (month/day), calling function will be available when exiting. If you wish, please consider changing your parking location.” This message 42f is, for example, a message notified in step S52 of FIG. 23. In this case, the location of the parking position to be changed (for example, the first parking position 73 where the vehicle was previously parked) may be indicated by displaying a map or the like. Note that the message 42f may be displayed on the information terminal 60 of the user, for example.

In the second modification, when the parking position where the vehicle 10 is parked is a position where the movement control for making the vehicle 10 to move to the exit position cannot be performed, the control ECU 20 notifies the user to change the parking position to a position where the movement control to the exit position is possible. In this way, the user who wants to call the vehicle 10 to the exit position can know where to park the vehicle 10, thereby improving usability regarding calling the vehicle 10 to the exit position.

Note that the control method described in the embodiment described above may be implemented by executing a control program prepared in advance by a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present disclosure is not limited to the embodiment described above, and modifications, improvements, and the like may be made as appropriate.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present disclosure is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present disclosure is not limited thereto.
(1) A control device (control ECU 20) for a moving object (vehicle 10), the control device including:
an external environment recognition unit (external environment recognition unit 55) configured to acquire external environment recognition data of the moving object;
a storage unit (storage unit 54) configured to store route information related to a movement route when the moving object moves from an entry start position to a stop position; and
a movement control unit (movement control unit 57) configured to perform movement control for moving the moving object to an exit position based on the external environment recognition data and the route information, in which
the route information includes route data indicating the movement route, stop position data indicating the stop position, and peripheral environment data indicating a feature of a peripheral environment of the movement route and the stop position based on the external environment recognition data,
when stop of the moving object at a first stop position identical to the stop position indicated by the stop position data is detected, the movement control unit performs first generation of an exit route from the first stop position to the exit position based on the route data and the stop position data, and
when stop of the moving object at a second stop position different from the stop position indicated by the stop position data is detected, the movement control unit performs second generation of an exit route from the second stop position to the exit position based on the route data and the peripheral environment data.

According to (1), when the moving object is stopped at the first stop position which is the same as a stop position where the moving object moves from the entry start position to the stop position at the previous time, the first generation of an exit route to the exit position is performed based on the first stop position and the previous movement route, and when the moving object is stopped at the second stop position which is different from the one at the previous time, the second generation of an exit route to the exit position is performed based on the peripheral environment data of the stop position and the movement route at the previous time. Therefore, even when the moving object is stopped at a position different from the previous one, there is no need to store route information regarding the movement route when stopping each time the vehicle is stopped, and the previous movement route can be used to generate an exit route to the exit position, so that movement control for causing the moving object to move to the exit position may be flexibly performed.
(2) The control device according to (1), in which
in the second generation when the stop of the moving object at the second stop position is detected, the movement control unit generates the exit route that merges with a route corresponding to the movement route indicated by the route data from a position of the moving object estimated by host position estimation based on the peripheral environment data.

According to (2), when the moving object is stopped at the second stop position different from the previous one, the second stop position is estimated from the peripheral environment data, and an exit route from the estimated second stop position to the exit position that merges with the route corresponding to the previous movement route is generated. Therefore, it is possible to flexibly perform the movement control for moving the moving object to the exit position by using the previous movement route.
(3) The control device according to (1) or (2), in which
the movement control unit determines whether the moving object is to stop at the first stop position based on a comparison between the movement route indicated by the route data and a movement route of the moving object.

According to (3), the stop position of the moving object may be accurately detected by comparing the movement route when the moving object is stopped the previous time with the movement route of the moving object at this time and determining whether the stop position of the moving object is the first stop position same as the previous stop position.
(4) The control device according to any one of (1) to (3), in which
the movement control unit determines whether the moving object is to stop at the first stop position based on a comparison between the stop position indicated by the stop position data and a stop position of the moving object.

According to (4), the stop position of the moving object may be accurately detected by comparing the stop position when the moving object is stopped the previous time with the stop position of the moving object at this time and determining whether the stop position of the moving object is the first stop position same as the previous stop position.
(5) The control device according to any one of (1) to (4), in which
after the exit route is generated by the first generation or the second generation, the movement control unit performs the movement control based on the exit route.

According to (5), it is possible to accurately perform the movement control of the moving object to the exit position based on the exit route generated in the first generation or the second generation.
(6) The control device according to (5), in which
the movement control unit performs the first generation or the second generation when the moving object is stopped, and
after the exit route is generated by the first generation or the second generation, the movement control unit notifies a user of the moving object that the movement control based on the exit route is possible and stores the exit route.

According to (6), generation of the exit route is performed when the moving object is stopped, and if calling to the exit position is possible, the user will be notified, thereby improving usability regarding calling the moving object to the exit position.
(7) The control device according to (6), in which
when performing the movement control based on the exit route, the movement control unit updates the exit route based on the external environment recognition data, and performs the movement control based on an exit route after updating.

As in (7), when the moving object is called, the movement control of the moving object is performed based on the exit route updated based on the external environment recognition data at the time of calling, thereby enabling more accurate and flexible movement control.
(8) The control device according to (6) or (7), in which
after notifying the user of the moving object that the movement control based on the exit route is possible, the movement control unit stores the exit route when receiving an instruction to execute the movement control based on the exit route from the user.

As in (8), when an instruction to execute exiting of the moving object is received from the user, the generated exit route is stored, thereby making it possible to efficiently process the route information regarding the exit route.
(9) The control device according to any one of (5) to (8), in which
the movement control unit performs the movement control based on the exit route according to an instruction from a user of the moving object.

According to (9), the moving object may be appropriately moved to the exit position based on an instruction from the user.
(10) The control device according to any one of (1) to (9), in which
when the stop of the moving object at the second stop position is detected and the second generation fails to generate the exit route, the movement control unit performs a notification to prompt the moving object to stop at the first stop position.

As in (10), when the moving object is stopped at the second stop position different from the previous one and the stop position is a position where the moving object cannot be moved to the exit position by the movement control, a notification is performed to prompt moving the moving object to the first stop position where movement control to the exit position may be performed, thereby further improving usability regarding calling the moving object to the exit position.
(11) The control device according to any one of (1) to (10), in which
the movement control is movement control based on an instruction from an information terminal carried by a user of the moving object.

According to (11), since the user can give an instruction of exiting of the moving object from the information terminal, it is possible to improve usability regarding calling the moving object to the exit position.
(12) A control method using a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data, the control method including:
when stop of the moving object at a first stop position identical to the stop position indicated by the stop position data is detected, performing, by the movement control unit, first generation of an exit route from the first stop position to the exit position based on the route data and the stop position data, and
when stop of the moving object at a second stop position different from the stop position indicated by the stop position data is detected, performing, by the movement control unit, second generation of an exit route from the second stop position to the exit position based on the route data and the peripheral environment data.

According to (12), when the moving object is stopped at the first stop position which is the same as a stop position where the moving object moves from the entry start position to the stop position at the previous time, the first generation of an exit route to the exit position is performed based on the first stop position and the previous movement route, and when the moving object is stopped at the second stop position which is different from the one at the previous time, the second generation of an exit route to the exit position is performed based on the peripheral environment data of the stop position and the movement route at the previous time. Therefore, even when the moving object is stopped at a position different from the previous one, there is no need to store route information regarding the movement route when stopping each time the vehicle is stopped, and the previous movement route may be used to generate an exit route to the exit position, so that movement control for causing the moving object to move to the exit position may be flexibly performed.
(13) A non-transitory computer-readable storage medium storing a control program for a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data,
the control program causing the movement control unit of the control device to execute a process including:
   when stop of the moving object at a first stop position identical to the stop position indicated by the stop position data is detected, performing first generation of an exit route from the first stop position to the exit position based on the route data and the stop position data, and,
   when stop of the moving object at a second stop position different from the stop position indicated by the stop position data is detected, performing second generation of an exit route from the second stop position to the exit position based on the route data and the peripheral environment data.

According to (13), when the moving object is stopped at the first stop position which is the same as a stop position where the moving object moves from the entry start position to the stop position at the previous time, the first generation of an exit route to the exit position is performed based on the first stop position and the previous movement route, and when the moving object is stopped at the second stop position which is different from the one at the previous time, the second generation of an exit route to the exit position is performed based on the peripheral environment data of the stop position and the movement route at the previous time. Therefore, even when the moving object is stopped at a position different from the previous one, there is no need to store route information regarding the movement route when stopping each time the vehicle is stopped, and the previous movement route may be used to generate an exit route to the exit position, so that movement control for causing the moving object to move to the exit position may be flexibly performed.

What is claimed is:

1. A control device for a moving object, the control device comprising:
an external environment recognition unit configured to acquire external environment recognition data of the moving object;
a storage unit configured to store route information related to a movement route when the moving object moves from an entry start position to a stop position; and
a movement control unit configured to perform movement control for moving the moving object to an exit position based on the external environment recognition data and the route information, wherein
the route information includes route data indicating the movement route, stop position data indicating the stop position, and peripheral environment data indicating a feature of a peripheral environment of the movement route and the stop position based on the external environment recognition data,
when stop of the moving object at a first stop position identical to the stop position indicated by the stop position data is detected, the movement control unit performs first generation of an exit route from the first stop position to the exit position based on the route data and the stop position data, and
when stop of the moving object at a second stop position different from the stop position indicated by the stop position data is detected, the movement control unit performs second generation of an exit route from the second stop position to the exit position based on the route data and the peripheral environment data.

2. The control device according to claim 1, wherein
in the second generation when the stop of the moving object at the second stop position is detected, the movement control unit generates the exit route that merges with a route corresponding to the movement route indicated by the route data from a position of the moving object estimated by host position estimation based on the peripheral environment data.

3. The control device according to claim 1, wherein
the movement control unit determines whether the moving object is to stop at the first stop position based on a comparison between the movement route indicated by the route data and a movement route of the moving object.

4. The control device according to claim 1, wherein
the movement control unit determines whether the moving object is to stop at the first stop position based on a comparison between the stop position indicated by the stop position data and a stop position of the moving object.

5. The control device according to claim 1, wherein
after the exit route is generated by the first generation or the second generation, the movement control unit performs the movement control based on the exit route.

6. The control device according to claim 5, wherein
the movement control unit performs the first generation or the second generation when the moving object is stopped, and
after the exit route is generated by the first generation or the second generation, the movement control unit notifies a user of the moving object that the movement control based on the exit route is possible and stores the exit route.

7. The control device according to claim 6, wherein
when performing the movement control based on the exit route, the movement control unit updates the exit route based on the external environment recognition data, and performs the movement control based on an exit route after updating.

8. The control device according to claim 6, wherein
after notifying the user of the moving object that the movement control based on the exit route is possible, the movement control unit stores the exit route when receiving an instruction to execute the movement control based on the exit route from the user.

9. The control device according to claim 5, wherein
the movement control unit performs the movement control based on the exit route according to an instruction from a user of the moving object.

10. The control device according to claim 1, wherein
when the stop of the moving object at the second stop position is detected and the second generation fails to generate the exit route, the movement control unit performs a notification to prompt the moving object to stop at the first stop position.

11. The control device according to claim 1, wherein
the movement control is movement control based on an instruction from an information terminal carried by a user of the moving object.

12. A control method using a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data, the control method comprising:
when stop of the moving object at a first stop position identical to the stop position indicated by the stop position data is detected, performing, by the movement control unit, first generation of an exit route from the first stop position to the exit position based on the route data and the stop position data, and
when stop of the moving object at a second stop position different from the stop position indicated by the stop position data is detected, performing, by the movement control unit, second generation of an exit route from the second stop position to the exit position based on the route data and the peripheral environment data.

13. A non-transitory computer-readable storage medium storing a control program for a control device for a moving object, the control device including an external environment recognition unit configured to acquire external environment recognition data of the moving object, a storage unit configured to store route information related to a movement route when the moving object moves from an entry start position to a stop position, and a movement control unit configured to perform movement control for moving the moving object to an exit position based on the external environment recognition data and the route information, the route information including route data indicating the movement route, stop position data indicating the stop position, and peripheral environment data indicating a feature of a peripheral environment of the movement route and the stop position based on the external environment recognition data,
the control program causing the movement control unit of the control device to execute a process comprising:
when stop of the moving object at a first stop position identical to the stop position indicated by the stop position data is detected, performing first generation of an exit route from the first stop position to the exit position based on the route data and the stop position data, and
when stop of the moving object at a second stop position different from the stop position indicated by the stop position data is detected, performing second generation of an exit route from the second stop position to the exit position based on the route data and the peripheral environment data.
